(19) United States
(12) Patent Application Publication
(10) Pub. No.: US 2010/0012854 A1
(43) Pub. Date: Jan. 21, 2010

(54) SCINTILLATOR PLATE

(76) Inventors: Martin Hoheisel, Erlangen (DE); Klaus Lowack, Dormitz (DE)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/504,760

(22) Filed: Jul. 17, 2009

(30) Foreign Application Priority Data
Jul. 18, 2008 (DE) 10 2008 033 759.5

(51) Int. Cl. G01J 1/58

(52) U.S. Cl. 250/484.4

(57) ABSTRACT

A scintillator plate has a radiation-permeable substrate on which a scintillator layer is applied. The substrate is composed of a cellular metallic material and has a smooth, closed outer skin. Such a scintillator plate has high mechanical stability with good radiation permeability.

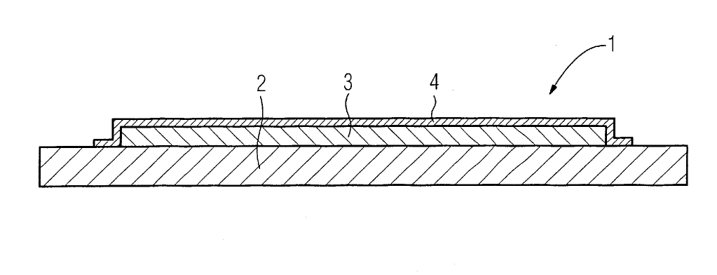

### BACKGROUND OF THE INVENTION

1. Field of the Invention

The present invention concerns a scintillator plate of the type having a radiation-permeable substrate on which the scintillator layer is applied.

2. Description of the Prior Art

Scintillator plates of the above type are used, for example, in digital x-ray detectors (flat panel detector) in combination with an active matrix (two-dimensional, pixelated photosensors) that is sub-divided into a number of pixel readout units with photosensors. The incident x-ray radiation is initially converted in the scintillator of the scintillator plate into visible light that is transduced by the photosensors into electrical charge and stored with spatial resolution. This process, known as indirect conversion, is described in, for example, the article by M. Spahn et al., “Flachbilddetektoren in der Röntgendiagnostik” in “Der Radiologe 43 (2003)”, Pages 340 through 350.

For detector surfaces larger than 20 cm×20 cm, the photosensors typically are produced based on amorphous silicon. For smaller detector surfaces, for example in dental technology, photosensors made of crystalline silicon (known as CCD sensors or CMOS sensors) can also be used.

Typical scintillator layers are composed of Csl:Tl (cesium iodide doped with thallium), Csl:Na (cesium iodide doped with sodium), Nal:Tl (sodium iodide doped with thallium) or similar materials that contain alkali halides. Csl is particularly well-suited as a scintillator material because it can be applied in a spicular (needle-shaped) form. In spite of a high layer thickness that ensures an optimal absorption of the x-ray radiation, a good spatial resolution of the x-ray image is obtained due to the spicular structure of cesium iodide.

Through U.S. Patent Application Publication No. 2003/0116714 A1 it is known to directly deposit a scintillator layer onto a photosensor, for example onto a CCD sensor. The photosensor thus serves as a substrate for the scintillator layer. In order to influence the optical properties of the cesium iodide in a desired manner, the photosensor forming the substrate, together with the vapor-deposited scintillator layer, must be subjected to a thermal treatment. Due to the temperatures required for this, the risk exists that the photodiodes of the photosensor will be degraded, so the probability of failure significantly increases.

In U.S. Pat. No. 6,573,506 an x-ray detector is described in which the scintillator layer is vapor-deposited onto an optical fiber (FOP, fiber optical plate) and is glued together with a photosensor executed as a CCD or CMOS chip. For cost reasons this technique is limited to small x-ray detectors, in particular for mammography and dental applications. Due to the gluing, the FOPs with their scintillator layers can no longer be removed from the photosensor without destroying them.

From U.S. Pat. No. 6,849,336 it is known to provide an x-ray detector with a radiation-permeable substrate contains carbon (glass carbon plate) with a scintillator layer. The coupling of such a flat substrate to a CCD sensor ensues (as is described in U.S. Pat. No. 6,469,305, for example) by means of an “immersion oil” (“matching oil”), and the sealing and connection to the pixelated photosensor ensues by means of a synthetic resin.

In DE 10 2005 029 196 A1, an x-ray detector is disclosed in which the scintillator plate has a radiation-permeable substrate made of aluminum, titanium or magnesium on which a scintillator layer is applied. The scintillator plate is executed as a scintillator casing and surrounds the scintillator layer on the side facing away from the photosensor.

A scintillator plate for an x-ray detector is known from DE 10 2006 022 138 A1 and DE 10 2006 024 893 A1 that has a radiation-permeable substrate on which a scintillator layer is applied, wherein the substrate has a layer thickness of approximately 300 μm to approximately 500 μm. The vapor-deposited scintillator layer has a thickness of approximately 50 μm to approximately 600 μm.

Substrates made from aluminum with layer thicknesses of approximately 300 μm are noncritical for detector surfaces up to approximately 25 cm×25 cm. For detector surfaces up to approximately 48 cm×48 cm, such thin substrates made from aluminum bend or buckle relatively easily during the manufacture of the scintillator plates or during the mounting of the x-ray detectors. These mechanical deformations can lead to tears in the substrate, so the absorption properties (and therefore the radiation-permeability of the substrate) are changed disadvantageously. Moreover, tears and/or buckles in the substrate severely affect the contact of the scintillator layer with the photodiodes in these regions, whereby the spatial resolution of the radiation detector is correspondingly severely degraded.

If substrates with layer thicknesses of more than 500 μm are used, the x-ray absorption correspondingly increases, and therefore the x-ray transparency decreases to the same degree. The sensitivity of such x-ray detectors is thus correspondingly low.

X-ray-transparent substrates made of plastic, which normally exhibit a better mechanical stability, do not withstand the thermal loads that occur in the manufacturing process, in particular the heat treatment to produce the optical properties.

A digital image system that has an x-ray image transducer is known from DE 196 15 595 A1. The digital x-ray image transducer has a photodiode matrix or of one or more CCD image sensors that are coupled with an x-ray image intensifier or a scintillator layer made of a luminophore layer sensitive to x-ray radiation.

### SUMMARY OF THE INVENTION

An object of the present invention is to provide a scintillator plate that exhibits a better mechanical stability with good radiation permeability, compared to conventional scintillator plates.

The scintillator plate according to the invention has a radiation-permeable substrate on which a scintillator layer is applied, and the substrate according to the invention is formed of a cellular metallic material and has a smooth, closed outer skin.

The substrate of the scintillator plate according to the invention is composed of a cellular metallic material, for example metal foam or metal sponge. Such materials are known from WO 2006/119657 A1, for example.

Metal foam is a material in which the voids do not form any significantly contiguous network but rather are fashioned in the form of pores. Open-pore metal foam is characterized by its porosity (pores per inch and pore size) in addition to its base material.

Metal sponge is a contiguous network with a metallic base that has voids in the form of an significantly contiguous network.

Due to the low density of these materials (advantageously less than 1 g/cm³) the substrate in the scintillator plate according to the invention can be executed significantly thicker than the known substrates composed of, for example, aluminum (density approximately 2.7 g/cm³). In spite of the large layer thickness, a lower radiation absorption in the substrate is achieved, and thus a correspondingly higher radiation-permeability of the substrate, with a simultaneously improved mechanical rigidity that results from the larger layer thickness.

Due to the higher mechanical rigidity of the substrate, flexing or a buckling does not occur during the manufacture of the scintillator plate and in the installation of the radiation detector. Tears in the substrate that increase the radiation absorption in this region (thus reduce the radiation permeability) and severely affect the contact of the substrate underside with the photodiodes are reliably reduced by the solution according to the invention. Even a radiation detector with a detector surface of up to 48 cm×48 cm or greater can be produced without problems and with good spatial resolution with the scintillator plate according to the invention.

Furthermore, given the solution according to the invention a good temperature resistance of the substrate consisting of a cellular metallic material is ensured, such that heat treatments during the manufacturing process are possible without problems and damage to the substrate is reliably avoided.

Due to the smooth, closed outer skin, application of the scintillator layer to the substrate without any problems is ensured. The smoothness and closure of the outer skin of the substrate can be achieved by a coating of the outer skin, meaning that at least one of the outer surfaces of the substrate is coated. The outer surfaces no longer exhibit any open-pored surfaces in the coated regions. Coating materials that are suitable for this are, for example, polyimide and polybenzoxazole, which have a sufficient thermal resistance.

For example, the coating of substrates is described in DE 10 2006 022 138 A1 and in DE 103 01 284 A1 with the example of aluminum substrates.

The scintillator plate according to the invention is suitable both for x-ray detectors and for other radiation detectors. The substrate according to the invention can also be used for coating with storage luminophores.

In an embodiment, the cellular metallic material is an aluminum alloy. The aluminum alloy advantageously contains small proportions of one of the following materials or a combination of these materials: silicon, magnesium, copper, manganese, beryllium, zinc.

Preferred aluminum alloys are, for example, AlSi6Cu4 (aluminum with 6% by weight silicon and 4% by weight copper) or AlSi10 (aluminum with 10% by weight silicon) or AlMg1SiO0.5 (aluminum with 1% by weight magnesium and 0.5% by weight silicon dioxide).

According to another embodiment, the cellular metallic material is a zinc alloy. The zinc alloy advantageously contains small proportions of one of the following materials or a combination of these materials: silicon, magnesium, copper, manganese, beryllium.

A preferred zinc alloy is ZnCu4 (zinc with 4% by weight copper).

### BRIEF DESCRIPTION OF THE DRAWINGS

The single FIGURE shows this scintillator plate in accordance with the invention in a section view that is significantly schematic and not to scale.

### DESCRIPTION OF THE PREFERRED EMBODIMENTS

In the FIGURE, a scintillator plate that, after its production in a known manner, is installed in a radiation detector (advantageously an x-ray detector) is designated with 1.

The scintillator plate 1 has a radiation-permeable substrate 2 on which is applied in a known manner a scintillator layer 3 made of thallium-doped cesium iodide (Csl:Tl). The substrate 2 according to the invention consists of a cellular metallic material (metal foam in the shown exemplary embodiment) and has a smooth, closed outer skin.

The smoothness and closure of the outer skin of the substrate (which is open-pored given metal foam) can be produced by a coating of the outer skin of the substrate 2, meaning that at least one of the outer surfaces of the substrate 2 is coated.

Due to the porosity, the density of the cellular metallic material in an open-pored metal foam made of an aluminum alloy is only approximately 6% to approximately 15% of that of the starting material. Sealed metal foams have a density of approximately 0.5 g/cm³ to approximately 0.7 g/cm³.

Due to the low density of p<1 g/cm³, radiation is absorbed distinctly less in the substrate 2 shown in the drawing than given a substrate made from aluminum plate (p≈2.7 g/cm³).

In the shown exemplary embodiment, a significantly larger layer thickness (for example approximately 2 mm) can therefore be selected for the substrate 2 made from a cellular metallic material without increasing the radiation absorption or reducing the radiation permeability relative to a substrate made from 0.5 mm aluminum plate, so a distinctly improved mechanical stability is simultaneously achieved.

In spite of the large layer thickness, a lower radiation absorption in the substrate 2 (and thus a correspondingly higher radiation permeability of the substrate 2) is achieved with a simultaneously improved mechanical rigidity that results from the larger layer thickness.

Due to the higher mechanical rigidity of the substrate 2, flexing or buckling do not occur during the manufacture of the scintillator plate 1 and in the installation of the radiation detector. Tears in the substrate 2 that increase the radiation absorption in this region (and thus reduce the radiation permeability) and severely impair the contact of the scintillator layer 3 with the photodiodes, are reliably prevented.

In the shown embodiment of the scintillator plate 1 according to the invention, the scintillator layer 3 has a passivation layer 4 that, for example, is applied in the manner according to DE 10 2006 022 138 A1 and DE 10 2006 024 893 A1.

Although modifications and changes may be suggested by those skilled in the art, it is the intention of the inventors to embody within the patent warranted hereon all changes and modifications as reasonably and properly come within the scope of their contribution to the art.

We claim as our invention:

1. A scintillator plate comprising:
a radiation-permeable substrate;
a scintillator layer applied on said substrate; and
said substrate consisting of a cellular metallic material and having a smooth, closed outer skin.

2. A scintillator plate according to claim 1, wherein said cellular metallic material is a metal foam.

3. A scintillator plate according to claim 1, wherein said cellular metallic material is a metal sponge.

4. A scintillator plate according to claim 1, wherein the cellular metallic material is an aluminum alloy.

5. A scintillator plate according to claim 4, wherein the aluminum alloy contains small proportions of at least one material selected from the group consisting of silicon, magnesium, copper, manganese, beryllium, and zinc.

6. A scintillator plate according to claim 1, wherein the cellular metallic material is a zinc alloy.

7. A scintillator plate according to claim 6, wherein the zinc alloy contains small proportions of at least one material selected from the group consisting of silicon, magnesium, copper, manganese, and beryllium.

8. A scintillator plate according to claim 1, wherein said cellular metallic material is AlSi6Cu4.

9. A scintillator plate according to claim 1, wherein said cellular metallic material is AlSi10.

10. A scintillator plate according to claim 1, wherein said cellular metallic material is AlMg1SiO0.5.

11. A scintillator plate according to claim 1, wherein said cellular metallic material is ZnCu4.

12. A scintillator plate according to claim 1, wherein the outer skin of the substrate is smoothed and sealed by a coating.
